(19) United States
(12) Patent Application Publication
(10) Pub. No.: US 2006/0193487 A1
(43) Pub. Date: Aug. 31, 2006

(54) Cordless headphone

(76) Inventors: Kin Lun Mok, Hong Kong (CN); King Lun Mok, Hong Kong (CN); Chi Yuen Lee, Hong Kong (CN)

Correspondence Address: ALIX YALE & RISTAS LLP, 750 MAIN STREET, SUITE 1400, HARTFORD, CT, 06103, US

(21) Appl. No.: 11/066,688

(22) Filed: Feb. 25, 2005

(51) Int. Cl. H04R 25/00

(52) U.S. Cl. 381/370; 381/374

(57) ABSTRACT

A cordless headphone has an earphone connected by a headband with a metallic support element. An audio signal receiver is located within the earphone and has an antenna port. The antenna port is connected to the metallic support element of the headband.

### BACKGROUND OF THE INVENTION

1. Field of the Invention

The current invention relates to personal entertainment systems and in particular to cordless headphones for such systems.

2. Description of Prior Art

In conventional headphones a wearer's movement and distance from audio equipment is limited by the length of the headphone cable. This problem is overcome by using cordless headphones. The entertainment system audio output is connected to a transmitter, and a receiver and antenna are located within one earphone for receiving the transmitted audio signal. This enables the wearer to move freely within the broadcast range of the transmitter.

There is one disadvantage to this arrangement. As the wearer moves his or her head comes between the signal transmitter and the antenna. This results in variations in signal strength which can cause variations in signal quality and output volume level. This problem can be overcome by including an external antenna rising above the top of the wearer's head or by placing an antenna in each earphone. However, both of these solutions increased complexity, manufacturing costs and possibly weight of the device.

### SUMMARY OF THE INVENTION

It is an object of the present invention to provide a cordless headphone, for personal entertainment system, which overcomes or at least ameliorates the above-mentioned problem. Is a further object of the present invention to provide a wireless headphone with an improved antenna arrangement which does not suffer from variations in the signal strength when a wearer moves their head.

According to the invention there is provided a cordless headphone comprising an earphone, a headband connecting the earphone for extending over a wearer's head and positioning the earphone, the headband having a metallic support element, an audio signal receiver located within the earphone and having an antenna port, and wherein the antenna port is connected to the metallic support element of the headband.

Preferably the cordless headphone has left and right earphone connected by the headband.

Preferably, the headband includes an inner soft headstrap for resting on the wearer's head and an outer resilient headband comprising the metallic support element.

Preferably, the headband includes a soft flexible padding covering the metallic support element.

Further aspects of the invention will become apparent from the following drawings and description.

### BRIEF DESCRIPTION OF THE DRAWINGS

Embodiments of the invention will now be described by way of example only and with reference to the accompanying drawings in which:

FIG. 1 is a perspective view of a headphone, and

FIG. 2 is a detail view of the right earphone showing the receiver and antenna connection.

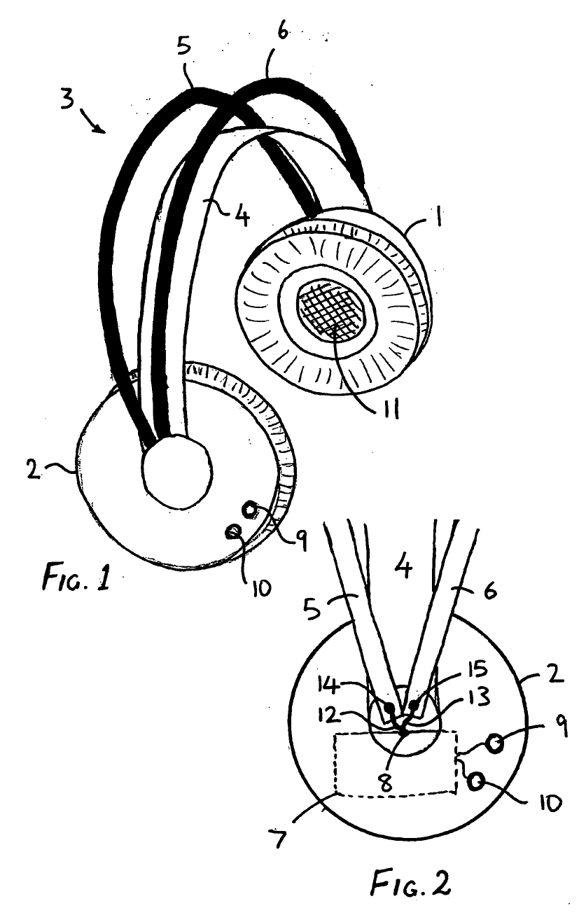

### DESCRIPTION OF THE PREFERRED EMBODIMENTS

In this specification the term metallic means made of or containing a metal, or having properties of a metal.

In the drawings there is depicted a wireless headphone consisting of a left earphone 1 and a right earphone 2 connected together by a headband 3. The headband 3 includes an inner soft flexible headstrap 4 that rests on a wearer's head and two outer resilient metallic support elements 5, 6 providing support to hold the earphones in place covering the wearer's ears. Located within the right earphone 2 is an audio receiver 7 for receiving transmitted audio signals and converting the audio signals to sound signals for output on speakers 11 within each earphone 1, 2. The audio receiver 7 includes an antenna port 8 which is connected to the metallic support elements 5, 6 by suitable conductors 12, 13. The cables or wires 12, 13 are coupled to the metallic support elements 5, 6 under the same fasteners 14, 15 securing the support elements 5, 6 to the earphone 2. The audio receiver 7 is also provided with a on/off knob 10 for turning the device on and off and a volume control knob 9 provided on the outside of earphone 2.

In an alternative embodiment the headphone also includes a tuner knob for selecting the received audio frequency so that the headphones can be to listening to public audio broadcasts.

The metallic support elements 5, 6 acts as an antenna to pick-up transmitted audio signals. Movement of the wearer, and in particular the wearer's head, does not affect the signal strength received by metallic support element of 5, 6.

In an alternative embodiment the headband is a single headstrap comprising soft flexible padding covering a metallic support element.

The current invention overcomes the problem of the prior art by utilising the metallic support element of the headphone's headband as an antenna. This eliminates the need for cables, an external antenna or an antenna in either earphone 1, 2. Additionally, because the headband passes over the wearer's head it is less likely to be blocked causing variations in signal strength. In the preferred embodiment the headband comprises a separate headstrap resting on the wearer's head with the metallic support elements raised above the wearer's head providing even greater signal reception.

Where in the foregoing description reference has been made to integers or elements having known equivalents then such are included as if individually set forth herein.

Embodiments of the invention have been described, however it is understood that variations, improvement or modifications can take place without departure from the spirit of the invention or scope of the appended claims.

What is claimed is:

1. A cordless headphone comprising:
an earphone,
a headband connecting the earphones for extending over a wearer's head and positioning the earphone, the headband having a metallic support element,
an audio signal receiver located within the earphone and having an antenna port, and wherein
the antenna port is connected to the metallic support element of the headband.

2. A cordless headphone comprising:
a left and a right earphone,
a headband connecting the left and right earphones for extending over a wearer's head and positioning the left and right earphones, the headband having a metallic support element,
an audio signal receiver located within one of said left or right earphones and having an antenna port, and wherein
the antenna port is connected to the metallic support element of the headband.

3. The cordless headphone of claim 2 wherein the headband includes an inner soft headstrap for resting on the wearer's head and an outer resilient headband comprising the metallic support element.

4. The cordless headphone of claim 2 wherein the headband includes a soft flexible padding covering the metallic support element.
